(19) United States
(12) Patent Application Publication
(10) Pub. No.: US 2018/0210254 A1
(43) Pub. Date: Jul. 26, 2018

(54) LIQUID CRYSTAL DISPLAY CIRCUIT AND METHOD FOR DRIVING THE SAME

(71) Applicant: SHENZHEN CHINA STAR OPTOELECTRONICS TECHNOLOGY CO., LTD., Shenzhen, Guangdong (CN)

(72) Inventor: Xiaoxiao WANG, Shenzhen, Guangdong (CN)

(21) Appl. No.: 15/307,007

(22) PCT Filed: May 10, 2016
(86) PCT No.: PCT/CN2016/081556

§ 371 Date: Oct. 27, 2016

(30) Foreign Application Priority Data
Apr. 13, 2016 (CN) 201610231666.7

(51) Int. Cl. G02F 1/133; G02F 1/1362; G09G 3/36

(52) U.S. Cl. CPC G02F 1/13306; G09G 2310/0264; G09G 3/36; G02F 1/136286

(57) ABSTRACT

A liquid crystal display circuit and a method for driving a liquid crystal display circuit are disclosed. The method has steps of: in a first driving period, a GOA driving circuit successively inputs driving signals to pixel units having positive polarities in each row, so that positive-polarity signals are written into the pixel units having the positive polarities by data lines; and in a second driving period, the GOA driving circuit successively inputs the driving signals to the pixel units having negative polarities in each row, so that negative-polarity signals are written into the pixel units having the negative polarities by the data lines.

### CROSS REFERENCE TO RELATED APPLICATIONS

This application is a U.S. National Phase application submitted under 35 U.S.C. § 371 of Patent Cooperation Treaty Application serial No. PCT/CN 2016/081556, filed on May 10, 2016, which claims the priority of China Patent Application serial No. 201610231666.7, filed on Apr. 13, 2016, the disclosures of which are incorporated herein by reference.

### FIELD OF THE INVENTION

The present invention relates to a display, and more particularly to a liquid crystal display circuit and a method of driving the liquid crystal display circuit.

### BACKGROUND OF THE INVENTION

In the production of liquid crystal panel, it is very important to reduce the production cost. Therefore, a DLS (Data Line Sharing) structure is generally applied to the liquid crystal panel. The number of scan lines (Gate lines) are doubled and the number of data lines are halved so as to reduce the number of IC driven by the source electrode to achieve the object of cost reduction.

Currently, in the method for driving the liquid crystal panel, dot inversion is more delicate for the flash spatial integration, which is refined to each sub-pixel. Therefore, the liquid crystal panel with dot inversion has the best effect of flashing suppression. However, the driving waveform of the dot inversion belongs to high frequency inversion so that the power consumption for driving the dot inversion is also great.

### SUMMARY OF THE INVENTION

A primary object of the present invention is to provide a liquid crystal display circuit and a method for driving a liquid crystal display circuit to solve the problem existing in the conventional technology that the driving power consumption of the liquid crystal display circuit is large.

To solve the above problem, the present invention provides technical solutions as described below.

The present invention provides a liquid crystal display circuit, comprising:

A plurality of pixel units arranged in a rectangular array, wherein two of the pixel units adjacent to each other in a column have opposite polarities, and two of the pixel units adjacent to each other in a row have opposite polarities;

a plurality of data lines connected with the pixel units to input data signals to the pixel units;

a plurality of scan lines respectively connected with the pixel units to transmit driving signals to the pixel units;

a GOA driving circuit respectively connected with the scan lines to input signals to each of the scan lines;

wherein the liquid crystal display circuit successively has a first driving period and a second driving period in each of frames; in the first driving period, the GOA driving circuit successively inputs the driving signals to the pixel units having positive polarities in each row so that the positive polarity signals are written into the pixel units having the positive polarities by the data lines; and in the second driving period, the GOA driving circuit successively inputs the driving signals to the pixel units having negative polarities in each row so that the negative polarity signals are written into the pixel units having the negative polarities by the data lines.

In the liquid crystal display circuit of the present invention, the scan lines successively form multiple series scan lines; wherein a 4k-3 series scan line and a 4k series scan line are connected with the pixel units having the positive polarities, and a 4k-2 series scan line and a 4k-1 series scan line are connected with the pixel units having the negative polarities, where k is a natural number greater than 0.

In the liquid crystal display circuit of the present invention, the number of the scan lines is 2160, so as to successively form 2160 series scan lines, and k is a natural number from 1 to 540.

According to the liquid crystal display circuit of the present invention, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from small to large, to each series scan line connected with the pixel units having the negative polarities.

According to the liquid crystal display circuit of the present invention, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from large to small, to each series scan line connected with the pixel units having the negative polarities.

In the liquid crystal display circuit of the present invention, the GOA driving circuit comprises a plurality of GOA driving units successively cascaded, and the GOA driving units comprises:

a clock circuit used for receiving clock signals, and connecting with a starting signal line and the scan lines;

a pull-down circuit used for connecting with a gate signal point, the scan lines, the starting signal line, and a fixed voltage source;

a bootstrap capacitor circuit used for connecting the gate signal point and the fixed voltage source;

a pull-up circuit used for connecting with the gate signal point, the scan lines, and the starting signal line; and

a pull-down maintenance circuit used for connecting with the gate signal point, the fixed voltage source, and the scan lines.

Furthermore, the present invention provides a method for driving a liquid crystal display circuit, comprising steps of:

providing a plurality of pixel units arranged in a rectangular array, wherein two of the pixel units adjacent to each other in a column have opposite polarities, and two of the pixel units adjacent to each other in a row have opposite polarities;

providing a plurality of data lines connected with the pixel units to input data signals to the pixel units;

providing a plurality of scan lines respectively connected with the pixel units to transmit driving signals to the pixel units; and;

providing a GOA driving circuit respectively connected with the scan lines to input signals to each of the scan lines;

wherein the liquid crystal display circuit in each of frames successively having a first driving period and a second driving period; in the first driving period, the GOA driving circuit successively inputs the driving signals to the pixel units having positive polarities in each row so that positive polarity signals are written into the pixel units having positive polarities by the data lines; and in the second driving period, the GOA driving circuit successively inputs the driving signals to the pixel units having negative polarities in each row so that negative polarity signals are written into the pixel units having the negative polarities by the data lines.

In the method for driving the liquid crystal display circuit of the present invention, the scan lines successively form multiple series scan lines; wherein a 4k-3 series scan line and a 4k series scan line are connected with the pixel units having the positive polarities, and a 4k-2 series scan line and a 4k-i series scan line are connected with the pixel units having the negative polarities, where k is a natural number greater than 0.

According to the method for driving the liquid crystal display circuit of the present invention, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from small to large, to each series scan line connected with the pixel units having the negative polarities.

According to the method for driving the liquid crystal display circuit of the present invention, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from large to small, to each series scan line connected with the pixel units having the negative polarities.

Compared with the current technology, in the liquid crystal display circuit and a method for driving the liquid crystal display circuit according to the present invention, all positive polarity signals in one frame are input and finished first and all negative polarity signals are input later. Therefore, the data signal input to the pixel units through the data line has only one-time switch in the polarity, so that the driving method is improved to a low frequency driving. The power consumption is reduced significantly.

### BRIEF DESCRIPTION OF THE DRAWINGS

FIG. 1 is a circuit diagram of the liquid crystal display circuit according to one preferred embodiment of the present invention.

FIG. 2 is a timing diagram of the first way for driving the liquid crystal display circuit of the present invention.

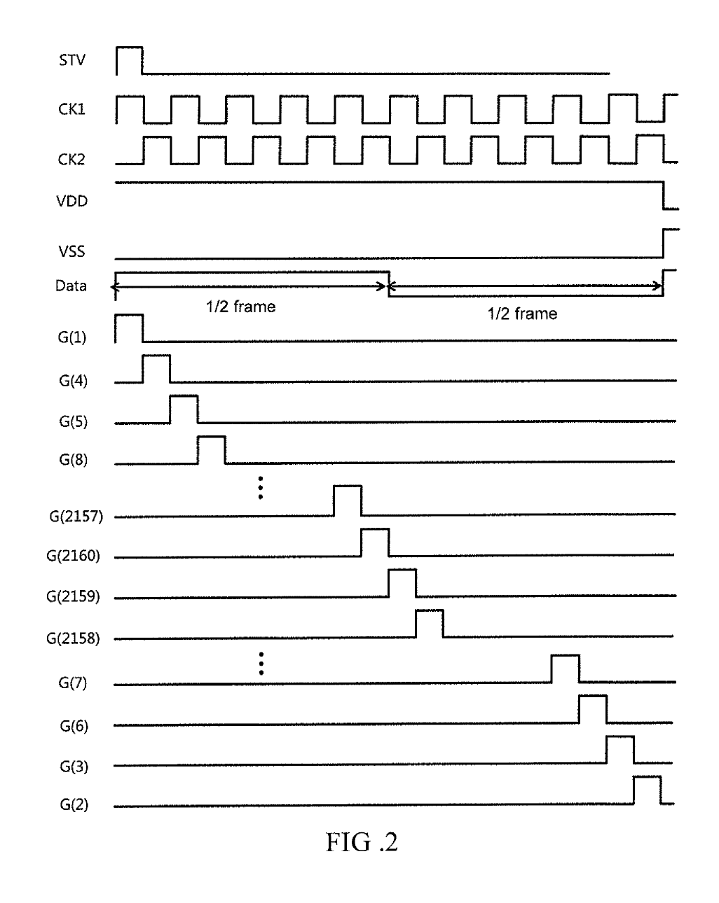

FIG. 3 is a timing diagram of the second way for driving the liquid crystal display circuit of the present invention.

FIG. 4 is a circuit diagram of the GOA driving unit in the liquid crystal display circuit of the present invention.

### DETAILED DESCRIPTION OF THE PREFERRED EMBODIMENTS

The detailed description of the following embodiments is used for exemplifying the specific embodiments of the present invention by referring to the accompany drawings. Furthermore, directional terms described by the present invention, such as upper, lower, front, back, left, right, inner, outer, side, etc., are only directions by referring to the accompanying drawings, and thus the directional terms are used to describe and understand the present invention, but the present invention is not limited thereto.

Similar units are referred to by the same number in the drawings.

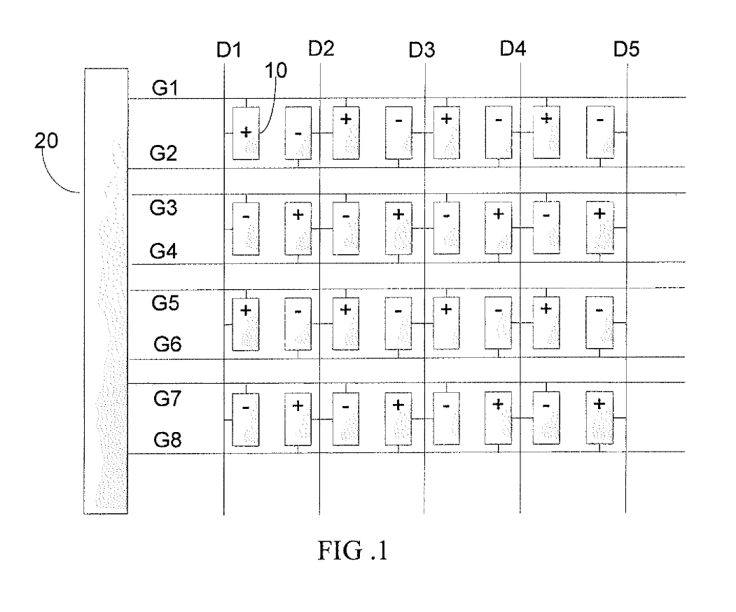

Referring to FIG. 1, which shows a liquid crystal display circuit according to one preferred embodiment of the present invention. The liquid crystal display circuit comprises a plurality of pixel units 10, a plurality of data lines (D1 to D8), a plurality of scan lines (G1 to G9), and a GOA driving circuit 20. Number of the data lines and the scan lines are determined according to a specific situation, and are not limited thereto. The drawing only shows partial data lines and scan lines.

The pixel units 10 are arranged in a rectangular array, the two of the pixel units 10 adjacent to each other in a column have opposite polarities, and the two of the pixel units 10 adjacent to each other in a row have opposite polarities.

Each of the data lines (D1 to D8) are respectively connected with the pixel units to output data signals to the pixel units 10 correspondingly.

The scan lines (G1 to G9) are respectively connected with the scan lines (D1 to D8) to input driving signals to the pixel units 10 correspondingly.

The GOA driving circuits 20 are respectively connected with the scan fines to input signals to each of the scan lines (G1 to G9).

The liquid crystal display circuit in each display image has successively a first driving period and a second driving period; in the first driving period, the GOA driving circuit successively inputs the driving signals to the pixel units 10 having positive polarities in each row so that the positive polarity signals are written into the pixel units 10 having the positive polarities by the data lines; in the second driving period, the GOA driving circuit successively inputs the driving signals to the pixel units 10 having negative polarities in each row so that the negative polarity signals are written into the pixel units 10 having the negative polarities by the data lines.

Specifically, in this embodiment, the number of the scan lines is 2160, and the 2160 pieces of the scan lines successively form 2160 series scan lines where one scan line corresponds to one series; wherein, the 4k-3 series scan line and the 4k series scan line are connected with the pixel units 10 having the positive polarities, and the 4k-2 series scan line and the 4k-1 series scan line are connected with the pixel units 10 having the negative polarities, where k is a natural number from 1 to 540. There are two driving ways to be applied. It can be understood that the number of the scan lines can be other values according to LCD resolution.

The first way for driving is: in the first driving period, the GOA driving circuit 20 successively inputs the driving signals, by the series from small to large, to each scan line connected with the pixel units 10 having the positive polarities, so that the positive polar signals are written into the pixel units 10 having the positive polarities by the data lines; in the second driving period, the GOA driving circuit 20 successively inputs the driving signals, by the series from small to large, to each scan line connected with the pixel units 10 having the negative polarities, so that the negative polar signals are written into the pixel units 10 having the negative polarities by the data lines. Specifically, two clock signals CK with duty cycle of 50% are applied to drive, FHD resolution for example, the positive polarity signals are written into the pixel units having the positive polarities in each row of the pixel units in each frame. When the positive polar signals are written, the GOA driving circuit 20 inputs the driving signals to the corresponding series scan lines according to the following order, so as to input the driving signals to the pixel units having the positive polarities correspondingly: 1→4→5→8→9→12 . . . 2152→2153→2156→2157→2160, this is the first driving period; next, the negative polarity signals are written into the pixel units having the negative polarities in each row, the GOA driving circuit 20 inputs the driving signals to the corresponding series scan lines according to the following order, so as to input the driving signals to the pixel units having the negative polarities correspondingly: 2159→2158→2155→2154 . . . →11→10→7→6→3→2, this is the second driving period.

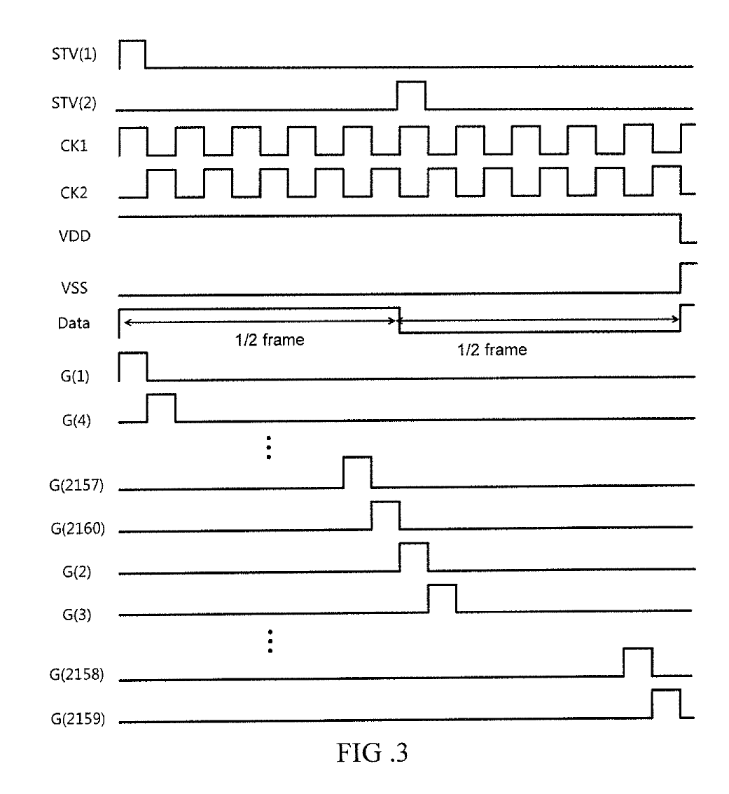

The second way for driving is: inputting the driving signals to each series scan lines connected with the pixel units 10 having the positive polarities by the series from small to large so that the positive polarity signals are successively written into the pixel units 10 having the positive polarities correspondingly by the data lines; in the second driving period, the GOA driving circuit 20 successively inputs the driving signals, by the series from large to small, into each series scan line connected with the pixel units 10 having the negative polarities, so that the negative polar signals are successively written into the pixel units 10 having the negative polarities correspondingly by the data lines. Specifically, two clock signals CK with duty cycle of 50% are applied to drive, as shown in FIG. 3, FHD resolution for example, the number of the scan lines is 2160, the positive polarity signals are written into the pixel units having the positive polarities in each row of the pixel units in each frame. When the positive polar signals are written, the GOA driving circuit 20 inputs the driving signals to the corresponding series scan lines according to the following order, so as to input the driving signals to the pixel units having the positive polarities correspondingly: 1→4→5→8→9→12 . . . 2152→2153→2156→2157→2160, this is the first driving period; next, the negative polarity signals are written into the pixel units having the negative polarities in each row, the GOA driving circuit 20 inputs the driving signals to the corresponding series scan lines according to the following order, so as to input the driving signals to the pixel units having the negative polarities correspondingly: 2→3→6→7 . . . 2154→2155→2158→2159, that is, the positive and negative polarities are both written from top to bottom. For realizing the timing, two staring signals STV: STV(1) connected with G(1), and STV(2) connected with G(2) are required for respectively controlling the driving signals and the starting point of writing the driving signals. The input-output waveforms are shown below in FIG. 3. In the same frame, the input signal of the data line shows only one time switch of the polarity, so that the driving frequency is reduced and the power consumption is also lowered significantly.

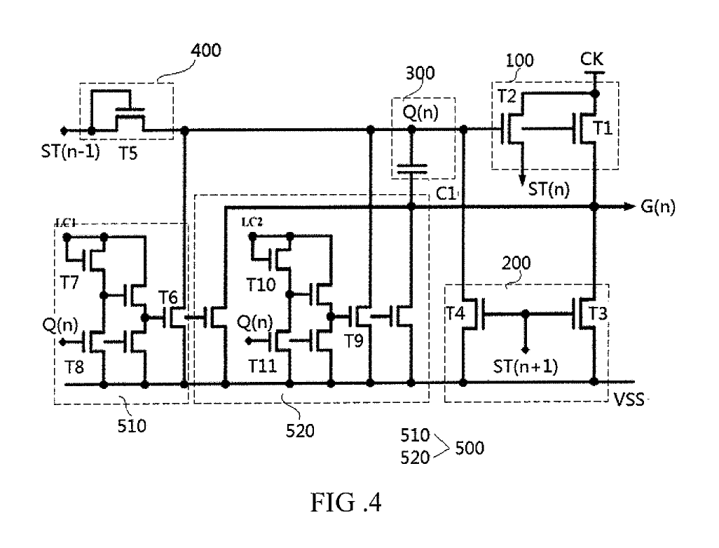

Specifically, as shown in FIG. 4, the GOA driving circuit comprises a plurality of GOA driving units successively cascaded. Wherein each of the GOA driving units comprises a clock circuit 100, a pull-down circuit 200, a bootstrap capacitor circuit 300, a pull-up circuit 400, and a pull-down maintenance circuit.

The clock circuit 100 is used for receiving multiple series clock signals, and connecting a starting signal line with the scan lines.

The pull-down circuit 200 is used for connecting gate signal points with a starting signal line of the scan lines and a fixed voltage source.

The bootstrap capacitor circuit 300 is used for connecting the gate signal point with the fixed voltage source.

The pull-up circuit 400 is used for connecting the gate signal point, and connecting the scan lines with the starting signal line; and

The pull-down maintenance circuit 500 is used for connecting the gate signal point with the fixed voltage source and the scan lines.

The clock circuit 100 comprises:

A first transistor T1 having a control end connected with the gate signal point Q(n). The first transistor T1 having an input end to receive the clock signal, and an output end connected with the n series scan line G(n); and

A second transistor T2 having a control end connected with the gate signal point. The second transistor T2 having an input end connected with the input end of the first transistor, and an output end of the second transistor T2 is connected with the n series starting signal line.

The pull-up circuit 400 comprises:

A fifth transistor T5 having a control end connected with the n−1 series starting signal line. The fifth transistor T5 having an input end connected with the control end of the fifth transistor T5, and an output end of the fifth transistor T5 is connected the gate signal point Q(n).

The pull-down circuit 200 comprises:

A third transistor T3 having a control end connected with the n+1 series starting signal line ST (n+1). The third transistor T3 having an input end connected with the fixed voltage source VSS, and an output end of the third transistor T3 is connected with the n series scan line G(n). And, a fourth transistor T4 having a control end connected with the control end of the third transistor T3 and the n+1 series starting signal line ST(n+1). The fourth transistor T4 having an input end to receive the fixed voltage source VSS. And output end of the fourth transistor T4 is connected with the gate signal point Q(n).

The bootstrap capacitor circuit 300 comprises:

A first capacitor Cl having two terminals connected with the gate signal point Q(n) and the n series scan line G(n).

The pull-up circuit 400 comprises:

A fifth transistor T5 having a control end connected with the n−1 series starting signal line. The fifth transistor T5 having an input end connected with the control end of the fifth transistor T5, and an output end of the fifth transistor T5 is connected the gate signal point Q(n). The pull-down maintenance circuit 500 comprises a first pull-down maintenance circuit 51 and a second pull-down maintenance circuit 520.

In the liquid crystal display circuit according to the present invention, all positive polarity signals are written and finished from top to bottom in one frame, and all negative polarity signals are written later. Therefore, the input signal of the data line has only a one-time switch in the polarity, so that the driving frequency is reduced and the power consumption is also lowered significantly.

The present invention further provides a liquid crystal display having the liquid crystal display circuit according to the abovementioned embodiment.

The present invention further provides a method for driving the liquid crystal display circuit, comprising steps of:

S501: providing a plurality of pixel units arranged in a rectangular array, wherein two of the pixel units adjacent to each other in a column have opposite polarities, and two of the pixel units adjacent to each other in a row have opposite polarities;

S502: providing a plurality of data lines connected with the pixel units to input data signals to the pixel units;

S503: providing a plurality of scan lines respectively connected with the pixel units to transmit driving signals to the pixel units;

S504: providing a GOA driving circuit respectively connected with the scan lines to input signals to each of the scan lines;

S505: the liquid crystal display circuit in each frame successively having a first driving period and a second driving period; in the first driving period, the GOA driving circuit successively inputs the driving signals to the pixel units having positive polarities in each row so that positive polarity signals are written into the pixel units having positive polarities by the data lines, in the second driving period, the GOA driving circuit successively inputs the driving signals to the pixel units having negative polarities in each row so that negative polarity signals are written into the pixel units having the negative polarities by the data lines.

The step S505 is described in detail hereinafter.

The number of the scan lines is 2160, and the 2160 pieces of the scan lines successively form 2160 series scan lines where one scan line corresponds to one series; wherein, the 4k-3 series scan line and the 4k series scan line are connected with the pixel units 10 having the positive polarities, and the 4k-2 series scan line and the 4k-1 series scan line are connected with the pixel units 10 having the negative polarities, where k is a natural number from 1 to 540. It can be understood that the number of the scan lines can be other values according to the LCD resolution. There are two driving ways to be applied.

In the step S505, two driving ways can be applied.

The first way for driving is: in the first driving period, the GOA driving circuit 20 successively inputs the driving signals, by the series from small to large, to each scan line connected with the pixel units 10 having the positive polarities, so that the positive polar signals are written into the pixel units 10 having the positive polarities by the data lines; in the second driving period, the GOA driving circuit 20 successively inputs the driving signals, by the series from small to large, to each scan line connected with the pixel units 10 having the negative polarities, so that the negative polar signals are written into the pixel units 10 having the negative polarities by the data lines. Specifically, two clock signals CK with duty cycle of 50% are applied to drive, FHD resolution for example, the positive polarity signals are written into the pixel units having the positive polarities in each row of the pixel units in each frame. When the positive polar signals are written, the GOA driving circuit 20 inputs the driving signals to the corresponding series scan lines according to the following order, so as to input the driving signals to the pixel units having the positive polarities correspondingly: 1→4→5→8→9→12 . . . 2152→2153→2156→2157→2160, this is the first driving period; next, the negative polarity signals are written into the pixel units having the negative polarities in each row, the GOA driving circuit 20 inputs the driving signals to the corresponding series scan lines according to the following order, so as to input the driving signals to the pixel units having the negative polarities correspondingly: 2159→2158→2155→2154 . . . →11→10→7→6→3→2, this is the second driving period. According to this embodiment, all positive polarity signals are written and finished from top to bottom in one frame, and all negative polarity signals are written later. Therefore, the input signal of the data line has only one-time switch in the polarity in the same frame, so that the driving frequency is reduced and the power consumption is also lowered significantly.

The second way for driving is: inputting the driving signals to each series scan lines connected with the pixel units 10 having the positive polarities by the series from small to large so that the positive polarity signals are successively written into the pixel units 10 having the positive polarities correspondingly by the data lines; in the second driving period, the GOA driving circuit 20 successively inputs the driving signals, by the series from large to small, into each series scan line connected with the pixel units 10 having the negative polarities, so that the negative polar signals are successively written into the pixel units 10 having the negative polarities correspondingly by the data lines. Specifically, two clock signals CK with duty cycle of 50% are applied to drive, as shown in FIG. 3, FHD resolution for example, the number of the scan lines is 2160, the positive polarity signals are written into the pixel units having the positive polarities in each row of the pixel units in each frame. When the positive polar signals are written, the GOA driving circuit 20 inputs the driving signals to the corresponding series scan lines according to the following order, so as to input the driving signals to the pixel units having the positive polarities correspondingly: 1→4→5→8→9→12 . . . 2152→2153→2156→2157→2160, this is the first driving period; next, the negative polarity signals are written into the pixel units having the negative polarities in each row, the GOA driving circuit 20 inputs the driving signals to the corresponding series scan lines according to the following order, so as to input the driving signals to the pixel units having the negative polarities correspondingly: 2→3→6→7 . . . 2154→2155→2158→2159, that is, the positive and negative polarities are both written from top to bottom. For realizing the timing, two staring signals STV: STV(1) connected with G(1), and STV(2) connected with G(2) are required for respectively controlling the driving signals and the starting point of writing the driving signals. The input-output waveforms are shown below in FIG. 3. In the same frame, the input signal of the data line has only one-time switch in the polarity, so that the driving frequency is reduced and the power consumption is also lowered significantly.

According to the liquid crystal display circuit and the method for driving a liquid crystal display circuit of the present invention, all positive polarity signals are written and finished from top to bottom in one frame, and all negative polarity signals are written later. Therefore, the input signal of the data line has only one-time switch in the polarity, so that the driving frequency is reduced and the power consumption is also lowered significantly.

The present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal display circuit, comprising:
a plurality of pixel units arranged in a rectangular array, wherein two of the pixel units adjacent to each other in a column have opposite polarities, and two of the pixel units adjacent to each other in a row have opposite polarities;
a plurality of data lines connected with the pixel units to input data signals to the pixel units;
a plurality of scan lines respectively connected with the pixel units to transmit driving signals to the pixel units;
a GOA driving circuit respectively connected with the scan lines to input signals to each of the scan lines;
wherein the liquid crystal display circuit successively has a first driving period and a second driving period in each of frames; in the first driving period, the GOA driving circuit successively inputs the driving signals to the pixel units having positive polarities in each row, so that positive-polarity signals are written into the pixel units having the positive polarities by the data lines; and in the second driving period, the GOA driving circuit successively inputs the driving signals to the pixel units having negative polarities in each row so that negative-polarity signals are written into the pixel units having the negative polarities by the data lines.

2. The liquid crystal display circuit according to claim 1, wherein the scan lines successively form multiple series scan lines; wherein a 4k-3 series scan line and a 4k series scan line are connected with the pixel units having the positive polarities, and a 4k-2 series scan line and a 4k-1 series scan line are connected with the pixel units having the negative polarities, where k is a natural number greater than 0.

3. The liquid crystal display circuit according to claim 1, wherein the number of the scan lines is 2160, so as to successively form 2160 series scan lines, and k is a natural number from 1 to 540.

4. The liquid crystal display circuit according to claim 2, wherein, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from small to large, to each series scan line connected with the pixel units having the negative polarities.

5. The liquid crystal display circuit according to claim 2, wherein, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from large to small, to each series scan line connected with the pixel units having the negative polarities.

6. The liquid crystal display circuit according to claim 1, wherein the GOA driving circuit comprises a plurality of GOA driving units successively cascaded, and the GOA driving units comprises:
a clock circuit configured to receive clock signals, and connect with a starting signal line and the scan lines;
a pull-down circuit configured to connect with a gate signal point, the scan lines, the starting signal line and a fixed voltage source;
a bootstrap capacitor circuit configured to connect the gate signal point and the fixed voltage source;
a pull-up circuit configured to connect with the gate signal point, the scan lines and the starting signal line; and
a pull-down maintenance circuit configured to connect with the gate signal point, the fixed voltage source and the scan lines.

7. A method for driving a liquid crystal display circuit, comprising steps of:
providing a plurality of pixel units arranged in a rectangular array, wherein two of the pixel units adjacent to each other in a column have opposite polarities, and two of the pixel units adjacent to each other in a row have opposite polarities;
providing a plurality of data lines connected with the pixel units to input data signals to the pixel units;
providing a plurality of scan lines respectively connected with the pixel units to transmit driving signals to the pixel units; and
providing a GOA driving circuit respectively connected with the scan lines to input signals to each of the scan lines;
wherein the liquid crystal display circuit in each of frames successively has a first driving period and a second driving period; in the first driving period, the GOA driving circuit successively inputs the driving signals to the pixel units having positive polarities in each row, so ₜhat positive-polarity signals are written into the pixel units having positive polarities by the data lines; and in the second driving period, the GOA driving circuit successively inputs the driving signals to the pixel units having negative polarities in each row, so that negative-polarity signals are written into the pixel units having the negative polarities by the data lines.

8. The method for driving the liquid crystal display circuit according to claim 7, wherein the scan lines successively form multiple series scan lines; wherein a 4k-3 series scan line and a 4k series scan line are connected with the pixel units having the positive polarities, and a 4k-2 series scan line and a 4k-1 series scan line are connected with the pixel units having the negative polarities, where k is a natural number greater than 0.

9. The method for driving the liquid crystal display circuit according to claim 8, wherein, in the first driving period, the GOA driving circuit successively inputs the driving signals, by a series from small to large, to each series scan line connected with the pixel units having the positive polarities; and
in the second driving period, the GOA driving circuit successively inputs the driving signals, by a series from small to large, to each series scan line connected with the pixel units having the negative polarities.

10. The method for driving the liquid crystal display circuit according to claim 8, wherein, in the first driving period, the GOA driving circuit successively inputs the driving signals, by a series from small to large, to each series scan line connected with the pixel units having the positive polarities; and in the second driving period, the GOA driving circuit successively inputs the driving signals, by a series from large to small, to each series scan line connected with the pixel units having the negative polarities.
